(19) United States
(12) Patent Application Publication
(10) Pub. No.: US 2009/0139938 A1
(43) Pub. Date: Jun. 4, 2009

(54) CYCLONE SEPARATOR AND METHOD FOR SEPARATING A SOLID PARTICLES, LIQUID AND/OR GAS MIXTURE

(76) Inventors: Per-Reidar Larnholm, Moss (NO); Robert Schook, Duiven (NL)

Correspondence Address: Myers Andras Sherman LLP, 19900 MacArthur Blvd., Suite 1150, Irvine, CA, 92612, US

(21) Appl. No.: 11/815,971

(22) PCT Filed: Feb. 10, 2006
(86) PCT No.: PCT/NL06/00069

§ 371 Date: Oct. 30, 2007

(30) Foreign Application Priority Data
Feb. 10, 2005 (NL) 1028238

(51) Int. Cl. B04C 3/00; B01D 21/26; B01D 45/12; B01D 19/00

(52) U.S. Cl. 210/788; 210/512.3; 55/452; 96/216; 95/271; 95/261

(57) ABSTRACT

The invention relates to a cyclone separator for separating a mixture containing solid particles, liquid and/or gas into a heavy fraction and a light fraction, the separator comprising: an outer casing (4) defining a flow space (6) through which the mixture is to flow; —flow body (5) arranged in the flow space along which the mixture to be separated can be carried; —at least one swirl element (10) arranged between the flow body and the outer casing, the swirl element defining a proximal region (E), an intermediate region (R) and a distal region (P), wherein in the proximal region the swirl element is adapted so as to gradually set the incoming mixture into a rotating movement for the purpose of separating the mixture into the heavy and light fraction and wherein in the distal region the swirl element is adapted so as to gradually reduce the rotating movement of the mixture for the purpose of recovering pressure.

The present invention relates to a cyclone separator for separating a mixture containing solid particles, liquid and/or gas into a heavy fraction and a light fraction. The invention also relates to a method of separating such mixture.

For separating of mixtures, such as mixtures of oil and gas, cyclone separators are known, wherein use is made of the difference in specific gravity between the various parts forming the mixture. A cyclone separator generally comprises a tube wherein a flow body is arranged. At the flow body guiding vanes are provided, the guiding vanes causing the pressurized mixture entering the tube to rotate. As a result of the centrifugal forces brought about by the rotation the relatively heavy fraction of the mixture, for example the oil, is flung outward, while the relatively light fraction of the mixture, for example the gas, travels in a zone around the flow body. By providing discharge means at suitable positions the separated light fraction or heavy faction can be discharged.

Cyclone separators are applied in a wide variety of situations. Inlet cyclones are employed in gravity separation vessels wherein some sort of pretreatment is performed on the mixture to be separated. The inlet cyclone is connected to the inlet of the gravity separation vessel and is provided with an outlet for the heavy fraction and an outlet for the light fraction, both outlets discharging into the interior of the gravity separation vessel for further separation of the mixture. An example of an inlet cyclone is disclosed in EP-A-1 187 667 A2.

Another type of cyclone separator is the so-called inline separator wherein the incoming mixture and at least a part of the outgoing mixture flows through a pipeline, the separator being essentially aligned with the pipeline. Inline cyclone separators can be subdivided in two different types.

In a first type, also known in the art as a degasser, the separator separates gas from liquid. An example of a degasser is disclosed in WO 01/00296 A1. In this degasser the liquid-continuous flow is brought into rotation by a plurality of swirl inducing guiding vanes. Due to the density difference between the gas and the liquid and the initiated centrifugal field, the gas is forced into the centre of the separator, implying a stable core of gas. Removal of the gas core is executed by means of a gas-outlet arrangement in the centre of the cyclone. The arrangement has a number of openings situated downstream of the swirl inducing guiding vanes. Due to the geometry of the separator, the removal of the gas takes place in radial direction.

A second type of inline cyclone separator is a device, also referred to as a deliquidiser, wherein a gas-continuous feed is brought into rotation by a number of swirl inducing guiding vanes. The deliquidiser separates in this case the liquid from the gas.

The liquid is forced towards the pipe-wall resulting in a stable liquid film moving in a direction of the gas-outlet. In the outlet region the gas and liquid are separated at a fixed streamwise position. The gas-outlet is a cylindrical open pipe, which is mounted in the flow space of the separator. An example of a deliquidiser is described on WO 02/056999 A1.

WO 02/056999 A1 also discloses additional guiding vanes (anti-spin elements) downstream of the first guiding vanes and downstream of the outlet of the heavy fraction. The additional guiding vanes are provided for reducing the rotation of the remaining mixture, i.e. in the case the gas, in order to regain pressure to the mixture flow.

However, in practice it has been proven extremely difficult to determine the exact geometry (i.e. the exact angle and shape) of the additional guiding vanes at the location where the remaining mixture reaches the vanes. If the geometry of the additional guiding vanes is not exactly matched with the local flow of the mixture, the recovery of pressure will be impeded to a large extent. A misalignment may initiate boundary layer disturbances resulting in energy losses and may even lead to re-entrainment of the separated phases, the creation of a large pressure drop and a reduced separation performance of the cyclone.

Furthermore the existing cyclone separators need both a separation chamber downstream of the swirl-inducing elements and a pressure recovery section, downstream of the separation chamber, wherein the rotation of the remaining mixture flow is removed. This renders the existing cyclone separators rather bulky.

It is an object of the present invention to provide a cyclone separator and a method of separating a mixture wherein the above-identified drawbacks of the existing cyclone separators are obviated.

It is a further object of the present invention to provide a cyclone separator and a separation method with improved separation characteristics and a reduced pressure drop across the separator.

It is an even further object of the present invention to provide a more compact cyclone separator with at least the same separation performance.

According to a first aspect of the present invention at least one of these objects is achieved in a cyclone separator for separating a mixture containing solid particles, liquid and/or gas into a heavy fraction and a light fraction, the separator comprising:
an outer casing defining a flow space through which the mixture is to flow;
a flow body arranged in the flow space along which the mixture to be separated can be carried;
at least one swirl element arranged between the flow body and the outer casing, the swirl element defining a proximal region, an intermediate region and a distal region, wherein in the proximal region the swirl element is adapted so as to gradually set the incoming mixture into a rotating movement for the purpose of separating the mixture into the heavy and light fraction and wherein in the distal region the swirl element is adapted so as to gradually reduce the rotating movement of the mixture for the purpose of recovering pressure.

The swirl element in the proximal region, also referred to as the entrance region or entrance length, gradually imposes rotation to the multi-phase mixture entering the separator. In the intermediate region, also referred to as the removal region or removal length, the relatively heavy fraction of the mixture, for instance oil in a gas/oil mixture, is flung into an outer zone adjacent the inner surface of the outer casing and the relatively light fraction, for instance the gas in the oil/gas mixture, is kept in a central zone close to the outer surface of the flow body. Because the heavy and light fraction are caused by the centrifugal forces imposed on them to more or less separate zones in the flow space, the heavy fraction and/or the light fraction can be removed in this region, as will be explained hereafter. In order to recover the pressure of the main mixture flow and therefore to minimise the overall pressure drop across the separator, the rotation of the remaining mixture in the distal region of the separator is reduced by the swirl element. When the mixture leaves the separator substantially all rotation may be removed and gained back in pressure.

In a preferred embodiment the swirl element includes at least a substantially uninterrupted guiding vane extending from the proximal region via the intermediate region to the distal region. This ensures that the geometry (orientation) of the swirl element at the entrance of the pressure recovery region automatically matches the direction of the rotating flow entering the distal region. Also the geometry of the swirl element at the entrance of the intermediate region matches the direction of the rotating local flow entering this region.

In another preferred embodiment the swirl element comprises two or more staggered guiding vanes, the geometry of which at the interfaces between the regions matches the local flow direction of the mixture.

In the intermediate region discharge means are provided for discharging the separated heavy fraction and/or light fraction from the flow space. In a first preferred embodiment the discharge means comprise one or more openings in the outer casing of the separator through which the heavy fraction can be discharged, and an outer flow passage defined between the inner surface of the outer casing and the flow body, the outer flow passage being connected to an outlet for discharge of the light fraction. In this embodiment the heavy fraction in the above-mentioned outer zone is discharged by the discharge means, whereas the light fraction in the centre zone continues to flow to the light fraction outlet of the separator.

In another preferred embodiment the discharge means comprise an inner flow passage defined in the flow body and provided with one or more openings, the openings connecting the flow space to the inner flow passage and the flow passage extending to an outlet for discharge of the light fraction. In this embodiment the light fraction in the centre zone is discharged by the discharge mean, while the heavy fraction in the outer zone continues to flow to outlet of the separator.

In a further preferred embodiment the swirl angle (α) of the one or more swirl elements increases in the proximal region, is substantially constant in the intermediate region and decreases in the distal region. Once the incoming mixture has been sufficiently brought into rotation in the proximal region, the light fraction and/or light fraction may be discharged through openings provided in the intermediate region.

In other embodiments the proximal region wherein the mixture is brought into rotation and the intermediate region wherein the light and/or heavy fraction is removed partly overlap. In these embodiments the removal of the heavy and/or light fraction takes place in the region wherein the swirl angle of the one or more swirl elements increases. In still other embodiments the intermediate region wherein the light and/or heavy fraction is removed partly overlaps with the distal region wherein the rotation of the remaining mixture is removed. Consequently, in these embodiments the removal of the heavy and/or light fraction takes place in the region wherein the swirl angle of the one or more swirl elements is reduced. Likewise the intermediate region may partly overlap with the proximal and distal regions.

It is noted that the openings in the outer casing and/or in the flow body may have any shape, for example circular, rectangular, slot-like, etc. The openings may also show mutually different shapes. However, in a further preferred embodiment the openings are elongated openings or slots extending obliquely with respect to the axial direction of the separator. In an even more preferred embodiment the slots extend substantially parallel to the swirl element(s). By arranging the elongated openings in an oblique manner with respect to the axial direction (z-direction in the drawings) of the separator or with respect to the swirl elements, the circumferential movement (rotation) of the rotating mixture can be followed more easily, resulting in a more natural way of guiding the heavy fraction through the openings in the outer casing and/or guiding the light fraction through the openings in the flow body, with less change of the direction of the heavy fraction and light fraction respectively. A further effect is that the rotating movement of the mixture remains more stable for a longer axial distance, as a result of which a higher separation efficiency and a lower pressure drop may be achieved.

In a further preferred embodiment the openings extend within an angle of less than 30 degrees with respect to the local flow direction of the mixture. In an even more preferred embodiment the openings extend substantially parallel with the local main flow direction of the mixture. This enables a highly natural way of guiding the relevant fraction through the openings and discharging the same.

When the angle between the longitudinal direction of an opening and the axial direction of the separator is between 0 and 90 degrees, or, preferably, between 50 and 90, or, even more preferably, is about 60-80 degrees, the openings extend in many practical configurations within a sufficiently small angle with respect to the local flow of the mixture in order to attain the desired effects.

In a further preferred embodiment the combined area of the openings corresponds substantially to the cross-sectional area of the inner passage so as to minimise the pressure drop across the openings.

In a further preferred embodiment the length of each of the openings in the flow body is about 10-50% of the circumference of the outer surface of the flow body. If the openings or slots are arranged with a length of about 50% of the circumference of the outer surface and the angle between the slots and the actual direction is about 60°, the length of the slots will be comparable to the mean diameter of the flow body. If the slots are made too long, the structural integrity of the flow body may be jeopardised, while if the slots are too short this will result in a relatively large pressure drop across the separator.

In a further preferred embodiment the flow body in the intermediate region comprises a substantially diverging portion, the diverging portion of the flow body being provided with one or more openings, for example perforations or elongated slots, through which the light fraction can be discharged. The proximal region and distal region may in this embodiment be substantially cylindrical. Other shapes however are conceivable as well.

The diverging portion can have a substantially conical shape. The conical shape may demonstrate a constant diameter increase per unit of length (also known as a “straight” cone, this type of cone may be manufactured relatively easily). Other types of cones are also conceivable, such as convex or concave like cone shapes, truncated cones, etc.

The provision of flow body, and, in another embodiment, also an outer casing, of which the intermediate part(s) diverge(s) has a positive effect on the separating characteristics of the separator. This may be caused by the enlarged area for removing the light fraction from the mixture.

As discussed earlier, the separation characteristics are improved according to a first aspect by having the incoming mixture follow a more natural path through the separator, either by providing angled elongated openings in the outer casing or in the flow body. According to a further aspect of the invention a more natural path can also be achieved by embodying the intermediate part of the flow body and/or of the outer casing with a divergent shape. However, the separation characteristics of the separator are even further improved when both aspects of the invention are combined.

As mentioned above, the separator may be part of a pipe line. In the inline cyclone the separator is essentially aligned with the pipeline.

According to another aspect of the invention a method is provided of separating a mixture containing solid particles, liquid and/or gas into a heavy fraction and a light fraction, the method comprising the steps of:
feeding the mixture through in inlet into a flow space of a cyclone separator of the type as described herein;
guiding the mixture along the one or more swirl elements in the proximal region, the swirl elements being operative so as to cause the mixture to rotate so as to fling the heavy fraction into an outer zone adjacent the inner surface of the outer casing and so as to keep the light fraction in a central region;
guiding the mixture along the swirl elements in an intermediate region and discharging the heavy fraction or light fraction in the said intermediate region;
guiding the remaining fraction along said swirl elements in the distal region, the swirl elements being operative so as to reduce the swirling movement of the remaining fraction;
discharging the remaining fraction.

Preferably the method comprises the steps of discharging the heavy fraction in the intermediate region through one or more openings provided in outer casing and/or the steps of discharging the light fraction through one or more openings provided in the flow body, the openings communicating with an inner passage extending axially in the flow body.

The separator as described herein may be used for separating a gas-liquid mixture into a heavy fraction essentially containing liquid and a light fraction essentially containing gas, for example gas and oil, or for separating a solid-gas mixture into heavy fraction essentially containing solid particles and a light fraction essentially containing gas. The separator may be used for separation of a mixture containing different liquids as well. When the mixture is a liquid-liquid mixture, the heavy fraction mainly contains a first liquid having a relatively high density, for instance water, and the light fraction mainly contains a second liquid having a relatively low density, for instance oil. Besides separating a two-phase mixture, the separator according to the invention may also be used for separating a mixture having more than two phases (multi phase mixture).

Further advantages, features and details of the present invention will be elucidated in the light of the following description of several preferred embodiments of the invention, with reference to the annexed drawings, in which:

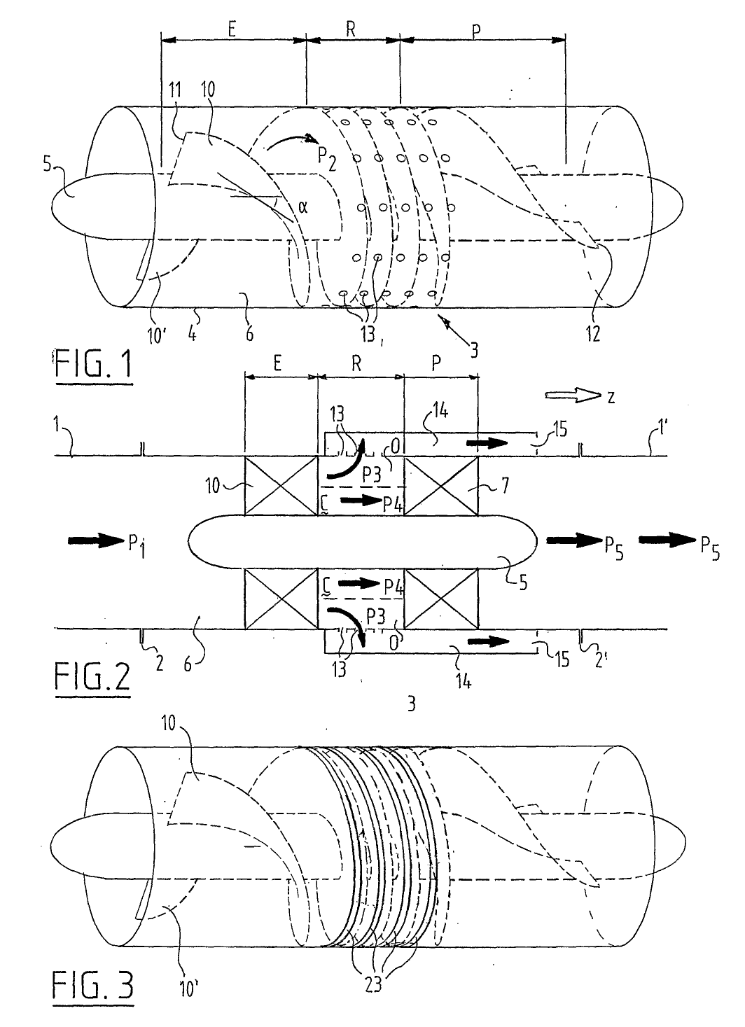

FIG. 1 shows a partly broken away view in perspective of a first preferred embodiment of a cyclone separator according to the present invention;

FIG. 2 shows a longitudinal section of the first preferred embodiment shown in FIG. 1;

FIG. 3 shows a partly broken away view in perspective of a second embodiment of the cyclone separator according to the invention;

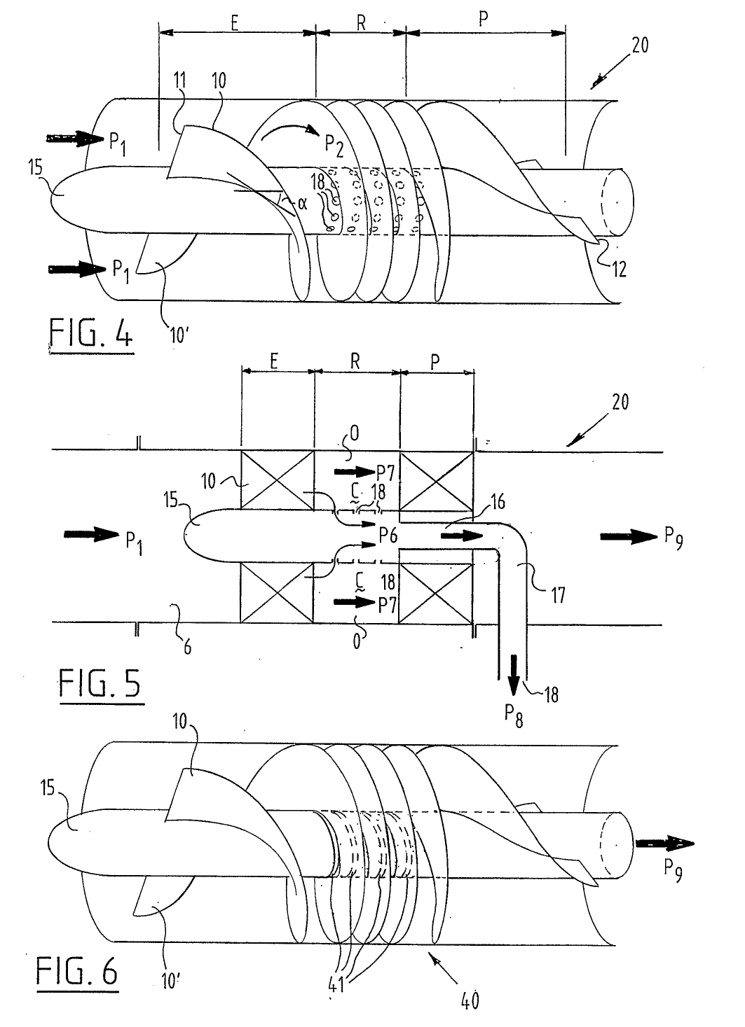

FIG. 4 shows a partly broken away view in perspective of a third preferred embodiment of the cyclone separator according to the present invention;

FIG. 5 shows a longitudinal section of the third preferred embodiment shown in FIG. 4;

FIG. 6 shows a partly broken away view in perspective of the fourth preferred embodiment;

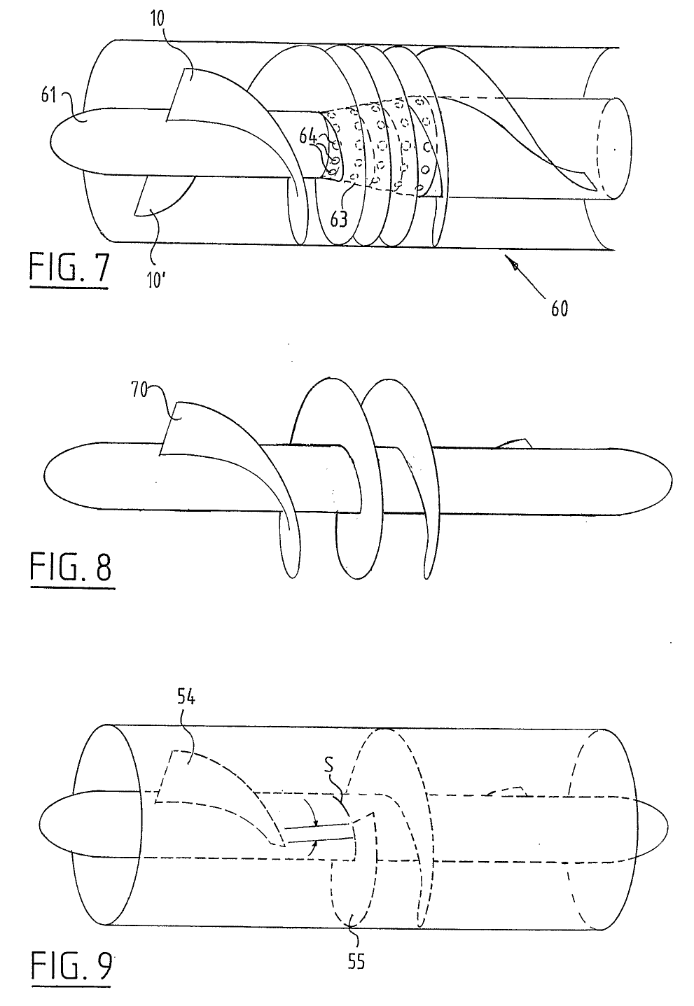

FIG. 7 shows a partly broken away view in perspective of a fifth preferred embodiment having a divergent intermediate region;

FIG. 8 shows a seventh preferred embodiment wherein the cyclone separator includes one uninterrupted guiding vane; and

FIG. 9 shows a further embodiment wherein the cyclone separator includes staggered swirl elements.

The embodiments of the separators according to the invention shown in the drawings are especially intended for separation of a gas phase (gas phase vapour) from a liquid phase (water/oil), for example in a pipeline leading to an oil platform. However, as indicated earlier, the separators can be used separating any mixture of one or more liquids, one or more gasses and/or one of more different types of solid particles.

FIGS. 1 and 2 show in a first embodiment a separator 3, comprising a tube 4 which at its proximal end is provided with an inlet 2 for connecting to the supply part of a pipeline 1 and which at its distal end is provided with an outlet 2′ for connecting to a discharge part 1′ of the pipeline. In the flow space 6 defined in the interior of the tube 4, a central flow body 5 is arranged, extending in the axial direction (or Z-direction, as is shown in FIG. 2). Between the inner surface of the tube 2 and the outer surface of the flow body 5 are arranged a curved guiding vane 10 and a further guiding vane 10′, as is clearly shown in FIG. 1. For clarity reasons only the description hereafter will refer to the guiding vane 10.

Between the proximal end 11 and the distal end 12 of the guiding vane 10 three different regions are defined. Extending from the proximal end in downstream direction, an entrance region (E) is defined. Extending from the trailing end 12 of the guiding vane 10 in upstream direction a pressure recovery region (P) is defined, while in the region between the entrance region (E) and pressure recovery region (P) an intermediate region or removal region (R) is defined. The function of the guiding vane in the entrance region (E) is to bring the incoming mixture (arrow P₁) flowing along the guiding vane 10 into rotation (as shown by arrow P₂, FIG. 1). In order to bring about the rotating movement of the mixture, the swirl vane angle α, defined as the angle between the axial direction (z-direction) and the guiding vane 10 at the outer surface of the flow body 5, starts with a value of about 0° and increases gradually in order to increase the curvature of the guiding vane.

In the intermediate region (R) the swirl vane or guiding vane angle α remains constant or nearly constant so as to keep the mixture rotating with more or less the same rotational speed. In the pressure recovery region (P) the swirl vane angle α is gradually reduced from the value in the intermediate region to substantially 0° so as to reduce the rotation of the mixture flowing along the guiding vane 10.

In the shown embodiment one edge of each guiding vane is attached to the inner surface of the tube or casing 4, while the opposite edge of the guiding vane is attached to the flow body 5. Other arrangements are however also possible, for example wherein the guiding vanes are attached to the flow body 5 only. In the embodiments shown the mixture is caused to rotate in a clockwise direction. One will understand that in other embodiments (not shown) the rotation may equally well be counterclockwise.

As a result of the curvature of the guiding vane 10 in the entrance region (E), a part of the mixture that is the relatively heavy fraction of the mixture, is flung outward by the rotating movement and is transported in a substantially annular outer zone O (FIG. 2) once it has arrived in the intermediate region (R). Another part of the mixture that is the relatively lightweight part thereof, will remain in a central zone or core zone C. In FIG. 2 the boundary between the outer zone O and zone C is denoted by a dotted line. In practice, however, there is no abrupt boundary between both zones. In fact a transition area between both zones exists.

The relatively heavy fraction of the mixture present in the outer zone O of the flow space in the intermediate region (R) will eventually reach one or more openings or perforations 13 provided in the outer case or tube 4. The heavy fraction is discharged (P₃) through the openings 13 into a passage 14 arranged concentrically around the tube 4. Passage 14 is provided with an outlet 15 that may be connected to a heavy fraction discharge pipe (not shown) for further transport.

As mentioned above, in order to regain pressure the guiding vane 10 in the pressure recovery region (P) is shaped such that the rotation of the remaining part of the mixture, in this case the light fraction, in other cases the heavy fraction, as will be explained later, is reduced. The light fraction flows in the downstream direction (P₄), rotating in the meantime as a consequence of the presence of the guiding vane 10. This rotating or swirling movement is reduced in the pressure recovery region (P) in that the light fraction is guided along the guiding vane 10 that presents a gradually diminishing swirl vane angle α. At the trailing end of the guiding vane 10 swirl vane angle α reaches a value of about 0°. When in this case the flow leaves the guiding vane 10, practically all rotation is removed and gained back in pressure. This results in a lower pressure drop across the total separator. Finally the light fraction is supplied (P₅) to the discharge part 1′ of the pipe line.

FIG. 3 shows a second embodiment of the present invention. In this figure like elements are denoted by like reference signs and the description thereof will be omitted here. In the second embodiment the generally circular perforations 13 in the outer casing 4 of the cyclone separator 3 have been replaced by a plurality of elongated openings or slots 23. Slots 23 provide access, in a similar way as described in connection with the first embodiment, to the passage 14 leading to the heavy phase discharge pipe 15. The slots 23 are arranged so as to extend obliquely (angle β with respect to the axial direction (Z-direction)) of the tube 2. Due to the oblique arrangement of the slots 23, the rotating heavy fraction in the intermediate region (R) will enter the slots 23 in a natural, smooth way. In other words, the stream lines of the rotating heavy fraction will locally be more or less parallel to the slots 23. As result of the natural way in which the heavy fraction enters the passage 14, the pressure drop across the slots 23 is minimized and the discharge of the heavy phase is improved which has a positive effect on the separation efficiency.

FIGS. 4 and 5 show a third embodiment of the present invention. In this figure like elements are denoted by like reference signs and the description thereof will be omitted here. In the third embodiment, the mixture entering the cyclone 20 (P₁) is brought into rotation by guiding vane 10 in the entrance region of the flow space 6. Similar to the earlier described embodiments, the relatively heavy fraction of the rotated mixture will end up (P₇) in the outer zone (O), while the light fraction of the mixture will more or less flow in the inner region (C) around the outer surface of the flow body 15. The flow body 15 is in this embodiment provided with an inner flow passage 16, for example comprising of one or more conduits arranged inside the flow body or at the outer surface of the flow body 15. The inner flow passage 16 may be connected to a light fraction discharge pipe 17 through which the light fraction may be discharged (P₈). The inner passage 16 may be reached by the light fraction in this flow space 6 through openings 18 in the flow body 15.

In use, the heavy fraction in the outer zone (O) will be transported (P₇) in the direction of the outlet. That part of the mixture reaching the pressure recovery region P, that is for the most part the heavy fraction, will be slowed down by the guiding vane 10 which in the pressure recovery region (P) is shaped so as to gradually reduce the rotation as mentioned above. The heavy fraction will eventually reach the pipe 1″ for further transport thereof (P₉). The light fraction in the inner zone (C) enters the inner passage 16 through the openings 18 (P₆) and is eventually discharged through the light phase outlet pipe 17 (P₈).

FIG. 6 shows a fourth preferred embodiment of the separator 40 according to the invention. The fourth embodiment is based on the earlier described third embodiment, wherein the perforations 17 provided in the flow body 15 providing access to the inner passage 16 are replaced by elongated openings or slots 41, that preferably extend in an oblique manner as is described in connection with the second embodiment. Due to the elongated slots which extend obliquely to the axial (Z-) direction of the separator and more or less parallel to the guiding vane 10, the light fraction will be able to follow a fairly smooth path through the slots 41 in order to enter the inner passage 16 and to leave the tube 4 at its distal end (P₉).

FIG. 7 shows a fifth embodiment of the separator 60 according to the invention. In this embodiment the flow body 61 in the intermediate region R has a divergent shape, meaning that the diameter of the flow body 61 in this region increases from the proximal to the distal end. In the embodiment shown a divergent portion 63 is provided wherein a plurality of openings 64 is arranged. In the figure the divergent portion 63 has a conical shape, but others shapes are also conceivable. The openings 64 provide access in a manner described previously to an inner passage 16 that is defined within the flow body 61. In another embodiment (not shown) the openings 64 have been replaced by elongated slots. The slots are arranged such that they extend obliquely with respect to the axial direction of the housing 4. Due to the oblique arrangement of the slots and the divergent shape of portion 63 of the flow body 61 the rotating light fraction ending up in the intermediate region R will enter the slots in a very natural, smooth way, which enables a high separation efficiency and a low pressure drop.

In a further embodiment, not shown, the outer casing 4 of the separator has a divergent shape near the divergent portion 63 of the flow body 61 as well. In this case the divergent portion 63 of the flow body 61 and the divergent portion of the outer casing 4 can run substantially parallel, so that a flow space along the associated part of the separator of a substantially constant cross-section is created. In other embodiments, however, the cross-section from the proximal position to the distal position of the divergent portion can increase or decrease.

FIG. 8 shows a further embodiment wherein only one guiding vane 70 is provided. The operation of this one guiding vane corresponds with that of the devices described earlier herein. Especially in situations wherein the swirl angle is small as a result of which the swirl blades (guiding vanes) would have a relatively large spacing, the use of only one swirl blade might prove to be insufficient. To solve this problem and to keep a limited mutual spacing, one or more swirl blades can be provided. The spacing between the swirl blades is hereby reduced, ensuring an improved flow of the mixture.

Finally, FIG. 9 shows a further embodiment wherein instead of one or more substantially uninterrupted swirl blades 10 a plurality of swirl blades 54, 55 is attached to the flow body 5 in a staggered fashion. Since the distances in swirl blade direction (S) between consecutive swirl blades 54 and 55 are restricted or, since the consecutive swirl blades even may overlap (as is denoted by two arrows in the embodiment shown in FIG. 9), the shape and swirl angle of the swirl blades always matches the direction of the mixture flow.

The present invention is not limited to the above described preferred embodiments whereof the rights applied for are defined by the following claims.

1. Cyclone separator for separating a mixture containing solid particles, liquid and/or gas into a heavy fraction and a light fraction, the separator comprising:
an outer casing defining a flow space through which the mixture is to flow;
a flow body arranged in the flow space along which the mixture to be separated can be carried;
at least one guiding vane (10,10′,54,55,70) arranged between the flow body and the outer casing, the guiding vane defining a proximal region and a distal region, wherein in the proximal region the element is adapted so as to gradually set the incoming mixture into a rotating movement for the purpose of separating the mixture into the heavy and light fraction and wherein in the distal region the guiding vane is adapted so as to gradually reduce the rotating movement of the mixture for the purpose of recovering pressure,
discharge means comprising one or more openings provided for discharging the separated heavy fraction and/or light fraction from the flow space, characterized in that the openings are provided in an intermediate region between the proximal region and distal region.

2. Cyclone separator as claimed in claim 1, wherein the swirl angle (α) of the one or more guiding vanes increases in the proximal region, is substantially constant in the intermediate region and decreases in the distal region.

3. Cyclone separator as claimed in claim 1, wherein said one or more openings are elongated openings (23,41) extending obliquely with respect to the axial direction of the separator and substantially parallel with the guiding vane in the intermediate region.

4. Separator of claim 1, comprising at least two guiding vanes (10,10′), wherein the elongated openings are slots (23,41) arranged in the mutual spacing between guiding vanes (10,10′).

5. Separator of claim 1, wherein the flow body in the proximal region has a substantially constant cross-section and in the intermediate region comprises a substantially diverging portion, the diverging portion of the flow body being provided with one or more openings through which the light fraction can be discharged.

6. Separator as claimed in claim 5, wherein the diverging portion has a substantially conical shape.

7. Separator as claimed in claim 5, wherein the divergent portion (63) of the flow body (61) and the divergent portion of the outer casing (4) run substantially parallel, so as to create a flow space along the associated part of the separator of a substantially constant cross-section.

8. Separator as claimed in claim 1, wherein the openings (23,41) extend within an angle of less than 30 degrees with respect to the local flow direction of the mixture.

9. Separator as claimed in claim 8, wherein the openings extend substantially parallel with the local main flow direction of the mixture.

10. Separator as claimed in any of the preceding claims, wherein the angle between the longitudinal direction of an opening and the axial direction of the separator is between 0 and 90 degrees.

11. Separator as claimed in claim 1, wherein the combined area of the openings corresponds substantially to the cross-sectional area of the inner passage.

12. Separator of claim 1, wherein the length of each of the openings is about 10-50% of the circumference of the outer surface of the flow body.

13. Separator of claim 1, wherein consecutive openings extend at shifted positions, so as to ensure a evenly distributed discharge of the light fraction through the openings.

14. Cyclone separator of claim 1, wherein a swirl element includes a substantially uninterrupted guiding vane extending from the proximal region via the intermediate region to the distal region.

15. Cyclone separator as claimed in claim 1, wherein the discharge means comprise one or more openings in the outer casing through which the heavy fraction can be discharged and an outer flow passage defined between the inner surface of the outer casing and the flow body, the outer flow passage being connected to an outlet for discharge of the light fraction.

16. Cyclone separator as claimed in claim 1, wherein the discharge means comprise:
an inner flow passage defined in the flow body, the flow passage extending to an outlet for discharge of the light fraction;
one or more openings in the flow body, the openings connecting the flow space to the inner flow passage.

17. Separator of claim 1, wherein the outer casing is substantially tubular and the outer passage is annular.

18. Separator of claim 1, wherein the separator is adapted to be arranged between pipes of a pipe line so as to constitute a part of a pipe line.

19. Gravity separation vessel provided with at least one cyclone separator of claim 1.

20. Method of separating a mixture containing solid particles, liquid and/or gas into a heavy fraction and a light fraction, the method comprising the steps of:
feeding the mixture through in inlet into a flow space of a cyclone separator as claimed in claim 1;
guiding the mixture along the one or more guiding vanes in the proximal region, the swirl elements being operative so as to cause the mixture to rotate so as to fling the heavy fraction into an outer zone adjacent the inner surface of the outer casing and so as to keep the light fraction in a central zone;
discharging the heavy fraction or light fraction through one or more openings (23,41);
guiding the remaining fraction along said swirl elements in the distal region, the swirl elements being operative so as to reduce the swirling movement of the remaining fraction;
discharging the remaining fraction;
characterized by
guiding the mixture along the swirl elements in an intermediate region between the proximal and distal region, wherein the heavy fraction or light fraction is discharged in said intermediate region through said one or more openings (23, 41).

21. Method as claimed in claim 20, wherein the swirl angle (α) of the one or more guiding vanes is substantially constant in the intermediate region so as to keep the mixture rotating with substantially the same rotational speed.

22. Method as claimed in claim 20, comprising guiding the mixture substantially parallel with the guiding vane in the intermediate region and discharging the heavy or light fraction in the intermediate region through elongated openings (23,41) extending obliquely with respect to the axial direction of the separator.

23. Method as claimed in claim 20, comprising discharging the heavy fraction in the intermediate region through one or more openings provided in outer casing.

24. Method as claimed in claim 20, comprising discharging the light fraction through one or more openings provided in the flow body, the openings communicating with an inner passage extending axially in the flow body.

25. Separator of claim 1, wherein the mixture is a liquid-liquid mixture, for instance water and oil, the heavy fraction of which mainly containing high density liquid, for instance water, and the light fraction of which mainly containing low density liquid, for instance oil.

26. Separator of claim 1, wherein the mixture contains gas and solid particles, the heavy fraction mainly containing solid particles and the light fraction mainly containing gas.

27. Separator of claim 1, wherein the mixture is a gas-liquid mixture, for instance natural gas and oil, the heavy fraction 6 mainly containing liquid and the light fraction mainly containing gas.

28. The cyclone separator of claim 1, wherein the angle between the longitudinal direction of an opening and the axial direction of the separator is between preferably between 50-90.

29. The cyclone separator of claim 1, wherein the angle between the longitudinal direction of an opening and the axial direction of the separator is between preferably about 60-80 degrees.

30. The method of claim 20 wherein the mixture is a liquid-liquid mixture, for instance water and oil, the heavy fraction of which mainly containing high density liquid, for instance water, and the light fraction of which mainly containing low density liquid, for instance oil.

31. The method of claim 20 wherein the mixture contains gas and solid particles, the heavy fraction mainly containing solid particles and the light fraction mainly containing gas.

32. The method of claim 20 wherein the mixture is a gas-liquid mixture, for instance natural gas and oil, the heavy fraction mainly containing liquid and the light fraction mainly containing gas.
